(19) United States
(12) Patent Application Publication
(10) Pub. No.: US 2012/0287155 A1
(43) Pub. Date: Nov. 15, 2012

(54) IMAGE DISPLAY METHOD AND APPARATUS

(75) Inventors: Kentaro HARADA, Yokohama-shi (JP); Masahiko INAKAGE, Tokyo (JP); Rika MATSUI, Tokyo (JP); Maki SUGIMOTO, Tokyo (JP); Makoto DANJYO, Tokyo (JP); Sayako SUZUKI, Tokyo (JP); Takashi NAOI, Tokyo (JP)

(73) Assignees: KEIO UNIVERSITY, Tokyo (JP); OLYMPUS CORPORATION, Tokyo (JP)

(21) Appl. No.: 13/478,321

(22) Filed: May 23, 2012

Related U.S. Application Data
(63) Continuation of application No. PCT/JP2010/071140, filed on Nov. 26, 2010.

(30) Foreign Application Priority Data
Nov. 27, 2009 (JP) 2009-270396

(51) Int. Cl. G09G 5/34

(52) U.S. Cl. 345/629

(57) ABSTRACT

An image display apparatus includes an image generation unit and a display unit. The image generation unit generates an image in which subject shape images shaped along the outer shapes of subjects are superimposed on a parallel image includes an array of multiple images to hide the borders or spaces between the multiple images. The display unit scrolls the image generated by the image generation unit in a direction in which the multiple images are arrayed and continuously and sequentially scroll-displays the multiple images.

### CROSS-REFERENCE TO RELATED APPLICATIONS

This application is a Continuation Application of PCT Application No. PCT/JP2010/071140, filed Nov. 26, 2010 and based upon and claiming the benefit of priority from prior Japanese Patent Application No. 2009-270396, filed Nov. 27, 2009, the entire contents of all of which are incorporated herein by reference.

### BACKGROUND OF THE INVENTION

1. Field of the Invention

The present invention relates to an image display method and an apparatus for the same to scroll-display multiple images in turn, as well as a scroll-display image data generation method and a recording medium.

2. Description of the Related Art

Heretofore, a so-called scroll display has been performed to display a plurality of images on a display screen while vertically and horizontally moving the images. In the scroll display, images larger in size than the display screen can also be displayed beyond the size limit of the display screen. Scroll-displaying multiple images on the display screen in turn enables, for example, a narrative expression as in a picture scroll.

A scroll display technique is disclosed in, for example, Jpn. Pat. Appln. KOKAI Publication No. 9-160746. The scroll display disclosed in No. 9-160746 comprises displaying a second image so that at least a part of the second image overlaps a first image, and moving the second image relative to the first image to increase the area of the region where the first image and the second image overlap.

### BRIEF SUMMARY OF THE INVENTION

An image display method according to aspect of the present invention comprises generating an image in which subject shape images shaped along the outer shapes of subjects are superimposed on a parallel image comprising an array of multiple images to hide the borders or spaces between the multiple images, scrolling the generated image in a direction in which the multiple images are arrayed, and continuously and sequentially scroll-displaying the multiple images.

An image display method according to aspect of the present invention comprises accessing a recording medium to acquire multiple images, using an electronic circuit to generate an image in which subject shape images shaped along the outer shapes of subjects are superimposed on a parallel image comprising an array of the multiple images to hide the borders or spaces between the multiple images, scrolling, on a display, the generated image in a direction in which the multiple images are arrayed, and continuously and sequentially scroll-displaying the multiple images.

An image display apparatus according to aspect of the present invention comprises an image generation unit which generates an image in which subject shape images shaped along the outer shapes of subjects are superimposed on a parallel image comprising an array of multiple images to hide the borders or spaces between the multiple images, and a display unit which scrolls the image generated by the image generation unit in a direction in which the multiple images are arrayed and continuously and sequentially scroll-displays the multiple images.

An image display apparatus according to aspect of the present invention comprises an image acquisition unit which accesses a recording medium to acquire multiple images, an image generation unit comprising an electronic circuit, the image generation unit generating an image in which subject shape images shaped along the outer shapes of subjects are superimposed on a parallel image comprising an array of the multiple images acquired by the image acquisition unit to hide the borders or spaces between the multiple images, a display, and a display unit which scrolls the image generated by the image generation unit in a direction in which the multiple images are arrayed and continuously and sequentially scroll-displays the multiple images on the display.

A scroll-display image data generation method according to aspect of the present invention comprises generating a parallel image comprising an array of multiple images, superposing subject shape images shaped along the outer shapes of subjects on the parallel image to hide the borders or spaces between the multiple images, and thereby generating scroll-display image data to continuously and sequentially scroll-display the multiple images.

An image display method according to aspect of the present invention comprises using an image display apparatus to scroll-display the scroll-display image data generated by the scroll-display image data generation method according to the scroll-display image data generation method.

A computer-readable recording medium according to aspect of the present invention recorded the scroll-display image data generated by the scroll-display image data generation method according to the scroll-display image data generation method.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing one embodiment of an image display apparatus according to the present invention;

FIG. 2 is a functional block diagram of the same apparatus;

FIG. 3 is a flowchart for scroll display in the same apparatus;

FIG. 4A is a schematic diagram showing multiple images acquired by an image acquisition unit in the same apparatus;

FIG. 4B is a schematic diagram showing multiple images that are changed in size by an image generation unit in the same apparatus;

FIG. 4C is a schematic diagram showing parallel images generated by the image generation unit in the same apparatus;

FIG. 4D is a schematic diagram showing parallel images which are generated by the image generation unit in the same apparatus and which have spaces there between;

FIG. 5A is a schematic diagram showing image data containing subjects which is acquired by the image acquisition unit in the same apparatus;

FIG. 5B is a schematic diagram showing subject shape images cut out from the image data acquired by the image acquisition unit in the same apparatus;

FIG. 5C is a schematic diagram showing subject shape images formed into a uniform size by the image generation unit in the same apparatus;

FIG. 6A is a schematic diagram showing parallel image data generated by the image generation unit in the same apparatus;

FIG. 6B is a schematic diagram showing a scroll-display image in which subject shape image data is superimposed on parallel image data generated by the image generation unit in the same apparatus;

FIG. 6C is a schematic diagram showing the scroll display of the scroll-display image generated by the image generation unit in the same apparatus; and

FIG. 7 is a schematic diagram illustrating the scroll display on a display in the same apparatus.

### DETAILED DESCRIPTION OF THE INVENTION

One embodiment of the present invention will be described hereinafter with reference to the drawings.

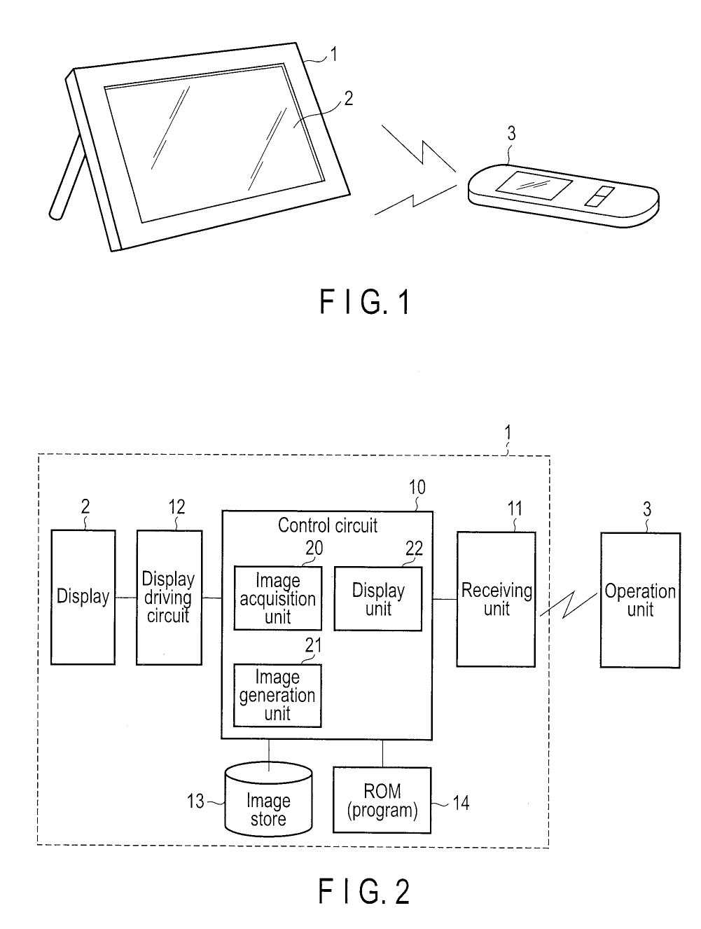

FIG. 1 shows a perspective view of an image display apparatus. Although display in the case of digital photo frames is described by way of example, an image display apparatus 1 is not limited thereto and display can be widely used for other purposes. For example, the image display apparatus 1 can be used for display on a large-sized screen at an exhibition, for the reproduction of image information recorded in a recording medium such as a DVD or a Blue-ray Disc (registered trademark), and for the reproduction of image information distributed by broadcasting or via the Internet.

The image display apparatus 1 has a display 2 including liquid crystal. The image display apparatus 1 continuously and sequentially scroll-displays multiple images on the display 2, for example, in response to the operation of an operation unit 3 (remote controller) by a user.

FIG. 2 shows a functional block diagram of the image display apparatus 1. The image display apparatus 1 includes a control circuit 10 including an electronic circuit. The control circuit 10 includes a computer having, for example, a CPU. A receiving unit 11, a display driving circuit 12, an image store 13 as a recording medium, and a program ROM 14 are connected to the control circuit 10. The receiving unit 11 wirelessly communicates with the operation unit 3. The receiving unit 11 receives operational information emitted from the operation unit 3, and sends this operational information to the control circuit 10. The display 2 is connected to the display driving circuit 12. The display driving circuit 12 drives the display 2 to display images. On receipt of a scroll display instruction from the control circuit 10, the display driving circuit 12 continuously and sequentially displays multiple images on the display 2 (this will hereinafter be referred to as scroll display).

Data of multiple images is stored in the image store 13. The image store 13 includes, for example, a recording medium such as a hard disk drive. The image store 13 may be, for example, placed far from the image display apparatus 1, may be connected to the image display apparatus 1 via a communication line such as a network, and may communicate with the image display apparatus 1 to receive image data.

An image display program is stored in the program ROM 14 in advance. In accordance with the image display program, multiple images are acquired by accessing the image store 13. On an array of these images (hereinafter referred to as parallel images), images shaped along the outer shapes of subjects (hereinafter referred to as subject shape images) are superimposed to hide the borders or spaces between the images. Scroll-display image data is thereby generated. The scroll-display image data is displayed on the display 2 in such a manner as to be scrolled in a direction in which the images are arrayed.

The control circuit 10 accesses the image store 13 and the program ROM 14 and sends instructions to the receiving unit 11 and the display driving circuit 12, and performs a series of controls to scroll-display multiple images on the display 2. The control circuit 10 reads and executes the image display program stored in the program ROM 14, and thereby includes the functions of an image acquisition unit 20, an image generation unit 21, and a display unit 22.

The image acquisition unit 20 accesses the image store 13 to acquire data of multiple images.

The image generation unit 21 generates scroll-display image data in which subject shape images shaped along the outer shapes of subjects are superimposed on parallel image data comprising an array of images acquired by the image acquisition unit 20 to hide the borders or spaces between the multiple images.

The display unit 22 displays, on the display 2, the scroll-display images generated by the image generation unit 21 in such a manner as to scroll the scroll-display images in a direction in which the multiple image data for generating the scroll-display image data is arrayed.

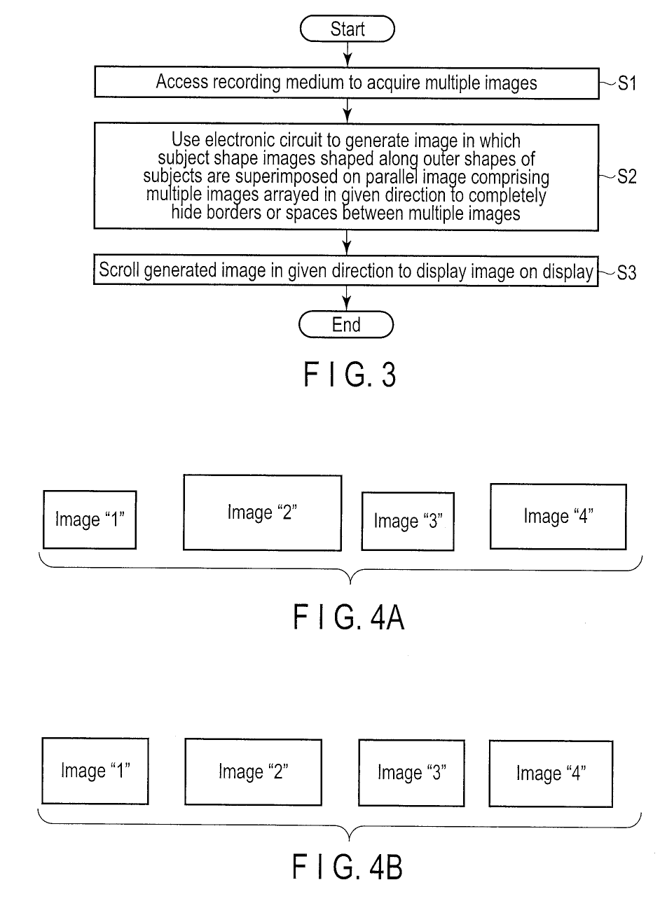

Now, the scroll display performed by the apparatus having the above-described configuration is described with reference to a scroll display flowchart shown in FIG. 3.

When the user operates the operation unit 3 to give an image acquisition instruction, the operation unit 3 sends the image acquisition instruction. On receipt of the image acquisition instruction from the operation unit 3 through the receiving unit 11, the image acquisition unit 20 accesses the image store 13 to acquire data of multiple images (step S1).

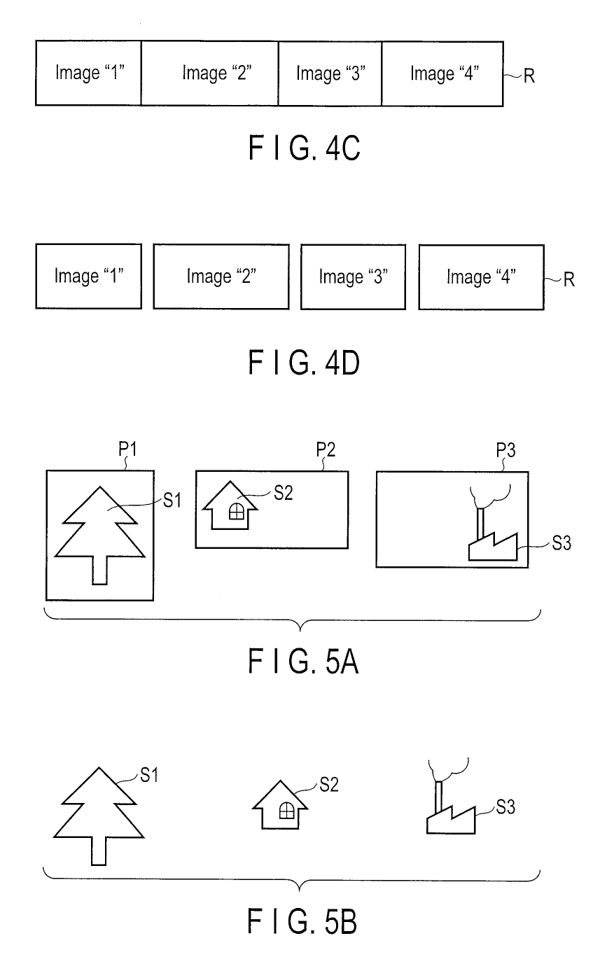

FIG. 4A shows, for example, four images 1 to 4 as the image data acquired from the image store 13. The four images 1 to 4 are preferably rectangular. Having a rectangular shape allows images 1 to 4 to be easily processed and handled later. Images 1 to 4 are not exclusively rectangular.

The image generation unit 21 generates scroll-display image data in which subject shape image data is superimposed on parallel image data comprising multiple image data that are acquired by the image acquisition unit 20 and that are arrayed, for example, in a given direction (step S2). The subject shape image data is shaped along the outer shapes of subjects to hide the borders or spaces between the images.

More specifically, as shown in FIG. 4B, the image generation unit 21 changes the sizes of images 1 to 4 acquired by the image acquisition unit 20 so that images 1 to 4 are uniform in height. When the difference of height among images 1 to 4 is small from the beginning or when images 1 to 4 are uniform in height, the image generation unit 21 can omit the process of changing the sizes of images 1 to 4.

As shown in FIG. 4C, the image generation unit 21 arrays images 1 to 4 uniform in height in a given direction to form parallel image data R. Images 1 to 4 are sequentially arrayed without any spaces formed between images 1 to 4.

Images 1 to 4 in the parallel image data R are arrayed, but not exclusively, in the long-side direction (horizontal direction in the drawing) of images 1 to 4, and may otherwise be arrayed in the short-side direction (vertical direction in the drawing) of images 1 to 4 or in other directions. Images 1 to 4 in the parallel image data R may be arrayed in the mixture of the long-side direction (horizontal direction in the drawing) and the short-side direction (vertical direction in the drawing). As shown in FIG. 4D, the parallel image data R may have spaces between images 1 to 4. There may be places where spaces are formed between images 1 to 4 and places where no spaces are formed between images 1 to 4.

In the meantime, the image generation unit 21 generates subject shape images shaped along the outer shapes of subjects to hide the borders or spaces between images 1 to 4.

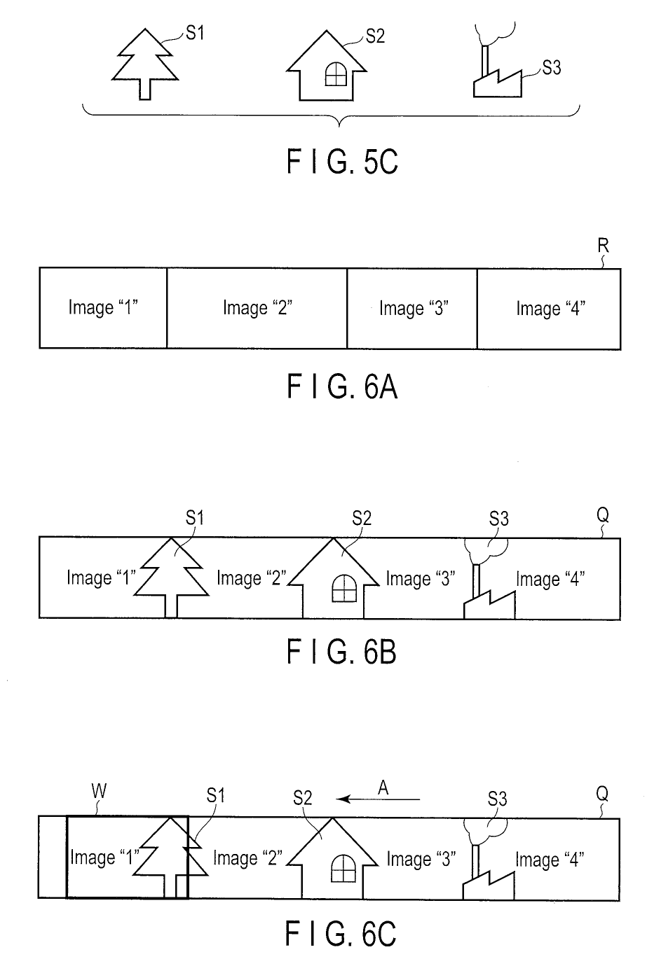

More specifically, from multiple image data acquired by the image acquisition unit 20, the image generation unit 21 acquires multiple image data containing subjects. In this case, the image generation unit 21 may acquire multiple image data containing subjects, for example, from images 1 to 4. In stead of the acquisition of images 1 to 4, the image generation unit 21 may acquire other multiple image data containing subjects from multiple image data stored in the image store 13. FIG. 5A shows a schematic diagram of multiple image data containing subjects which are acquired from the image store 13, for example, three image data P1 to P3.

As shown in FIG. 5B, the image generation unit 21 cuts out three subject shape image data S1 to S3 shaped along the outer shapes of subjects from the image data P1 to P3, respectively. In order to differentiate the subjects from the background, the subject shape image data S1 to S3 are cut out by using the difference of brightness and tone of the images, by template matching, or by using the in-focus degrees of the images and thus comparing their frequency components. For the in-focus degrees of images, the fact that the subjects are usually in focus and the background is out of focus is used.

As shown in FIG. 5C, the image generation unit 21 forms the cut subject shape image data S1 to S3 into a uniform size. The subject shape image data S1 to S3 have sizes necessary to hide the borders or spaces between images 1 to 4 in the parallel image data R shown in FIG. 4C and FIG. 4D.

If the subject shape image data S1 to S3 are stored in the image store 13 from the beginning, the process of cutting out the subject shape image data S1 to S3 is not necessary. If the subject shape image data S1 to S3 have a uniform image size from the beginning, the process of forming the subject shape image data S1 to S3 into a uniform size is not necessary. The subject shape image data S1 to S3 may be acquired from the outside, for example, via a communication line. Silhouette image data may be used as the subject shape image data S1 to S3.

The image generation unit 21 superimposes the subject shape image data S1 to S3 on the parallel image data R shown in FIG. 6A to hide the borders or spaces between images 1 to 4, thereby generating scroll-display image data Q shown in FIG. 6B. The image generation unit 21 temporarily stores the generated scroll-display image Q, for example, in the image store 13.

In the scroll-display image data Q, the subject shape image data S1 to S3 are near views, and the parallel image data R is a distant view. As a result, parts corresponding to the parallel image data R behind the subject shape image data S1 to S3 are hidden. The borders or spaces between images 1 to 4 are completely hidden by superposing the subject shape image data S1 to S3 on the positions between images 1 to 4 included in the parallel image data R.

The image generation unit 21 does not have to completely hide the borders or spaces between images 1 to 4. In this case, the image generation unit 21 may subject unhidden parts of the borders or spaces between images 1 to 4 to processing such as gradation.

The display unit 22 reads the scroll-display image data Q stored in the image store 13, and displays, on the display 2, the scroll-display image data Q in such a manner as to scroll the scroll-display image data Q in a direction in which images 1 to 4 for generating the scroll-display image data Q are arrayed (step S3).

FIG. 6C shows the concept of the scroll display. A heavy-line rectangular frame W on the left indicates the frame of a display region. The display unit 22 moves the scroll-display image data Q, for example, in an arrow direction A relative to the display region frame W. The display unit 22 thereby displays an image data portion in the display region frame W on the display 2.

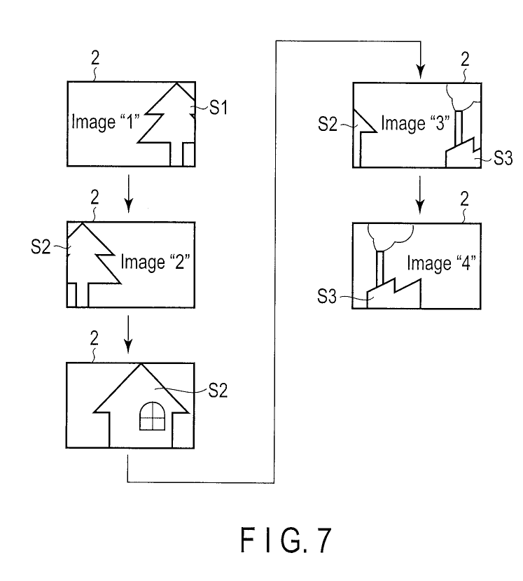

FIG. 7 schematically illustrates the scroll display on the display 2. For example, image 1 is first displayed on the display 2, and image 1 moves, for example, to the left at a given speed. Simultaneously with the movement of image 1, the subject shape image data S1 is displayed on the right side of the screen to follow image 1. The subject shape image data S1 also moves to the left at a given speed. Simultaneously with the movement of the subject shape image data S1, image 2 is displayed on the right side of the screen to follow the subject shape image data S1. After this, the subject shape image data S2, image 3, the subject shape image data S3, and image 4 are continuously and sequentially scroll-displayed.

Thus, according to the embodiment described above, multiple images 1 to 4 are acquired by accessing the image store 13. Images 1 to 4 are arrayed to generate parallel image data R. Subject shape image data S1 to S3 shaped along the outer shapes of subjects are superimposed on the parallel image data R to hide the borders or spaces between images 1 to 4 to generate scroll-display image data Q. The scroll-display image data Q is displayed on the display 2 in such a manner as to be scrolled in a direction in which images 1 to 4 are arrayed. As a result, the borders or spaces between images 1 to 4 are hidden by the subject shape image data S1 to S3 which are arrayed as near views. The borders or spaces between images 1 to 4 do not become an obstruction to viewing. In the meantime, the subject shape image data S1 to S3 have outer shapes extending along subjects. Therefore, the borders between images 1 to 4 do not become an obstruction to viewing.

As the subject shape image data S1 to S3 and images 1 to 4 which are not the subject shape image data S1 to S3 are alternately scroll-displayed, a continuous image can be displayed without any blanks between images 1 to 4 that are scroll-displayed. Moreover, images 1 to 4 can be scroll-displayed so that a switch of the data is less obstructive to viewing.

For example, the display unit 22 moves the scroll-display image data Q not exclusively in the arrow direction A relative to the display region frame W, and may move the scroll-display image data Q in a direction opposite to the arrow direction A.

The display unit 22 moves the scroll-display image data Q not exclusively relative to the display region frame W, and may move the display region frame W relative to the scroll-display image data Q.

The present invention is not completely limited to the embodiment described above, and modifications of components can be made at the stage of carrying out the invention without departing from the spirit thereof. Further, various inventions can be made by properly combining the components disclosed in the embodiment described above. For example, some of all the components shown in the embodiment may be eliminated. Moreover, components in different embodiments may be suitably combined together.

What is claimed is:

1. An image display method comprising:
generating an image in which subject shape images shaped along the outer shapes of subjects are superimposed on a parallel image comprising an array of multiple images to hide the borders or spaces between the multiple images;
scrolling the generated image in a direction in which the multiple images are arrayed; and
continuously and sequentially scroll-displaying the multiple images.

2. The image display method according to claim 1,
wherein the parallel image is formed by changing the sizes of the multiple images and arraying the multiple images changed in size in a given direction.

3. The image display method according to claim 1,
wherein the direction in which the multiple images are arrayed is the short-side direction of the multiple images, the long-side direction of the multiple images, or the mixture of the short-side direction and the long-side direction of the multiple images.

4. The image display method according to claim 1,
wherein the subject shape images are cut out from the multiple images and thereby generated.

5. The image display method according to claim 1,
wherein the subject shape images are stored in a storage device in advance and obtained from the storage device.

6. The image display method according to claim 1,
wherein the image in which the subject shape images are superimposed is configured so that the subject shape images are near views and the multiple images are distant views.

7. An image display method comprising:
accessing a recording medium to acquire multiple images;
using an electronic circuit to generate an image in which subject shape images shaped along the outer shapes of subjects are superimposed on a parallel image comprising an array of the multiple images to hide the borders or spaces between the multiple images;
scrolling, on a display, the generated image in a direction in which the multiple images are arrayed; and
continuously and sequentially scroll-displaying the multiple images.

8. An image display apparatus comprising:
an image generation unit which generates an image in which subject shape images shaped along the outer shapes of subjects are superimposed on a parallel image comprising an array of multiple images to hide the borders or spaces between the multiple images; and
a display unit which scrolls the image generated by the image generation unit in a direction in which the multiple images are arrayed and continuously and sequentially scroll-displays the multiple images.

9. The image display apparatus according to claim 8,
wherein the image generation unit changes the sizes of the multiple images and arrays the multiple images changed in size in a given direction to form the parallel image.

10. The image display apparatus according to claim 8,
wherein the image generation unit sets, as the direction in which the multiple images are arrayed, the short-side direction of the multiple images, the long-side direction of the multiple images, or the mixture of the short-side direction and the long-side direction of the multiple images.

11. The image display apparatus according to claim 8,
wherein the image generation unit cuts out the subject shape images from the multiple images and thereby generates the subject shape images.

12. The image display apparatus according to claim 8, including
a storage device to store the subject shape images in advance,
wherein the image generation unit acquires the subject shape images from the storage device.

13. The image display apparatus according to claim 8,
wherein the image generation unit generates the image in which the subject shape images are superimposed so that the subject shape images are near views and the multiple images are distant views.

14. An image display apparatus comprising:
an image acquisition unit which accesses a recording medium to acquire multiple images;
an image generation unit comprising an electronic circuit, the image generation unit generating an image in which subject shape images shaped along the outer shapes of subjects are superimposed on a parallel image comprising an array of the multiple images acquired by the image acquisition unit to hide the borders or spaces between the multiple images;
a display; and
a display unit which scrolls the image generated by the image generation unit in a direction in which the multiple images are arrayed and continuously and sequentially scroll-displays the multiple images on the display.

15. A scroll-display image data generation method comprising:
generating a parallel image comprising an array of multiple images;
superposing subject shape images shaped along the outer shapes of subjects on the parallel image to hide the borders or spaces between the multiple images, and thereby generating scroll-display image data to continuously and sequentially scroll-display the multiple images.

16. An image display method comprising using an image display apparatus to scroll-display the scroll-display image data generated by the scroll-display image data generation method according to claim 15.

17. A computer-readable recording medium recording the scroll-display image data generated by the scroll-display image data generation method according to claim 15.
